(19) United States
(12) Patent Application Publication
(10) Pub. No.: US 2013/0016286 A1
(43) Pub. Date: Jan. 17, 2013

(54) INFORMATION DISPLAY SYSTEM, INFORMATION DISPLAY METHOD, AND PROGRAM

(71) Applicants: Toshiyuki Nomura, Tokyo (JP); Yuzo Senda, Tokyo (JP); Kyota Higa, Tokyo (JP)

(72) Inventors: Toshiyuki Nomura, Tokyo (JP); Yuzo Senda, Tokyo (JP); Kyota Higa, Tokyo (JP)

(73) Assignee: NEC CORPORATION, Tokyo (JP)

(21) Appl. No.: 13/638,452

(22) PCT Filed: Mar. 28, 2011
(86) PCT No.: PCT/JP2011/057542

§ 371 Date: Sep. 28, 2012

(30) Foreign Application Priority Data
Mar. 30, 2010 (JP) 2010-078122

(51) Int. Cl. H04N 5/265

(52) U.S. Cl. 348/578; 348/E05.056

(57) ABSTRACT

Disclosed is an information display system provided with: a signal analyzing unit which analyzes the audio signals obtained from a predetermined location and which generates ambient sound information regarding the sound generated at the predetermined location; an ambient expression selection unit which selects an ambient expression which expresses the content of what a person is feeling from the sound generated at the predetermined location on the basis of the ambient sound information; and an ambient expression and video superimposing unit which superimposes the ambient expression on the video of a video signal obtained from the predetermined location.

### TECHNICAL FIELD

The present invention relates to an information display system, an information display method, and a program therefor.

### BACKGROUND ART

There is a case in which an atmosphere of a remote location should be conveyed to a user In such a case, capturing a video of the above remote location and transmitting its video to the user makes it possible to convey the visual atmosphere of the above field to the user.

However, it is impossible to completely convey the atmosphere of the above location only by the conveyance of the captured video.

In such a case, collecting surrounding sounds with a microphone etc. installed in the above field and causing the user to listen to the collected sound makes it possible to convey the surrounding atmosphere. However, there is a problem that the surrounding atmosphere of a talker cannot be completely conveyed because only a monaural sound can be collected with a microphone and an earphone.

Thereupon, the stereo telephone apparatus capable of realizing telephone communication having a high quality sound and a sense of presence has been proposed (for example, Patent literature 1).

In the stereo telephone apparatus described in the Patent literature 1, the stereo telephone machine partners can stereophonically perform mutual communication with each other, whereby they can have a conversation with the voice that is more stereophonic than the monaural sound.

However, the surrounding environmental sound of the above field cannot be well conveyed to the user during a call between the stereo telephone machine users because the stereo telephone apparatus described in the Patent literature 1 conveys the surrounding environmental sound using a microphone for call.

Thereupon, the technology of Patent literature 2 has been proposed as a technology that aims for well conveying the environmental sound of the above field to the user. In the technology of Patent literature 2, when a caller wants to convey the surrounding atmosphere or the like to a recipient during a call, the caller inputs the telephone number of a content server together with the telephone number of the recipient. As the content server, there exist the content server that collects the environmental sound around the caller and distributes it in real time as stereoscopic sound data, the content server that distributes music, and the like. Because the information of the content server specified in the transmission side is notified when a telephone machine originates a call, the reception side telephone apparatus acquires the stereoscopic sound data by making a connection to the content server based on this IP address information and reproduces the stereoscopic sound with a surround system connected to the telephone apparatus. This enables the recipient to feel almost the same atmosphere while having a call with the caller.

Conveying the video and the sound collected in the remote location to the user using the technologies as described above makes it possible to convey the atmosphere of the above field to the user.

### CITATION LIST

### Patent Literature

PTL 1: JP-P1994-268722A

PTL 2: JP-P2007-306597A

### SUMMARY OF INVENTION

### Technical Problem

By the way, the human being, who lives in the various sounds including the voice, feels atmosphere for the sound itself other than the meaning/content of the voice. For example, now think about the field in which many human beings are present, the sound of people's moving around, the sound of people's opening documents, and the like are generated even though all human beings do not utter the voice. In such a case, for example, the human being feels that the above field is in a situation of “Gaya Gaya (onomatopoeia in Japanese)”. On the other hand, there is also a case in which no sound is present at all or in a case in which the sound pressure level is almost next to silence. In such a case, the human being feels that the above field is in a situation of “shiin (mimetic word in Japanese)”. In such a manner, the human being takes in various atmospheres from the sound (including the case of silence) that is felt in the above field.

However, the technologies of the Patent literature 1 and the Patent literature 2, which aim for causing the sound, which is being generated in the above field, to reappear as faithfully as possible and reproducing the sound field having a sense of presence, cannot convey the various atmospheres other than the sound the human being feels.

In addition, even though the video and sound conveyed from the remote location are reproduced as they stand, how an object within the video moves and which atmosphere is present are hardly conveyed in a direct manner.

Thereupon, the present invention has been accomplished in consideration of the above-mentioned problems, and an object thereof is to provide an information display system that allows the atmosphere to be more easily shared mutually, and a movement of an object and an atmosphere within the video to be easily conveyed intuitively by representing the atmosphere of the above field and the mutual situations with an atmosphere expression word that appeals to the human being's sensitivity and superimposing it upon the video, an information display method therefor and a program therefor.

### Solution to Problem

The present invention for solving the above-mentioned problems is an information display system, comprising: a signal analyzing unit that analyzes audio signals obtained from a predetermined field, and prepares atmospheric sound information related to a sound that is being generated in said predetermined field; an atmosphere expression word selecting unit that selects an atmosphere expression word expressing what a person feels from the sound that is being generated in said acquisition location based on said atmospheric sound information; and an atmosphere expression word video superimposing unit that superimposes said atmosphere expression word upon a video of video signals obtained from said predetermined field.

The present invention for solving the above-mentioned problems is an information display method, comprising: analyzing audio signals obtained from a predetermined field, and preparing atmospheric sound information related to a sound that is being generated in said predetermined field; selecting an atmosphere expression word expressing what a person feels from the sound that is being generated in said acquisition location based on said atmospheric sound information; and superimposing said atmosphere expression word upon a video of video signals obtained from said predetermined field.

The present invention for solving the above-mentioned problems is a program for causing an information processing apparatus to execute: a signal analyzing process of analyzing audio signals obtained from a predetermined field, and preparing atmospheric sound information related to a sound that is being generated in said predetermined field; an atmosphere expression word selecting process of selecting an atmosphere expression word representing what a person feels from the sound that is being generated in said acquisition location based on said atmospheric sound information; and an atmosphere expression word video superimposing process of superimposing said atmosphere expression word upon a video of video signals obtained from said predetermined field. cl Advantageous Effect of Invention

The present invention, as compared with the conventional technology that, so far, pays attention to reappearance of the faithful sound field and video in order to obtain a sense of presence, namely, the atmosphere of the above field and the mutual situations, allows the atmosphere to be more easily shared mutually by more clearly expressing the atmosphere of the above field and the mutual situations with the video having the atmosphere expression word appealing to the human being's sensitivity superimposed thereupon, thereby making it possible to obtain a sense of presence that have not been obtained so far.

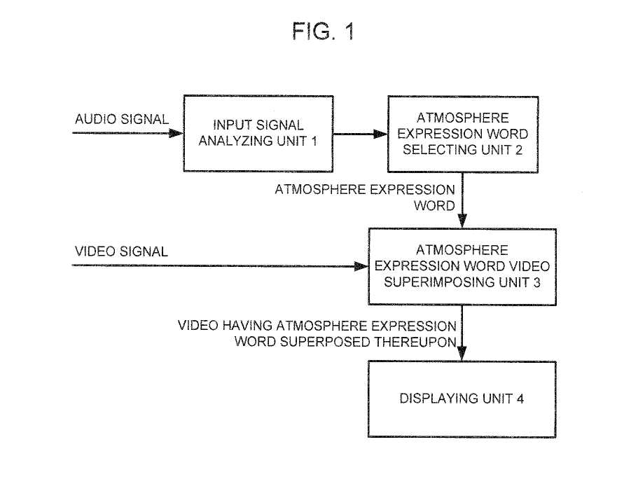

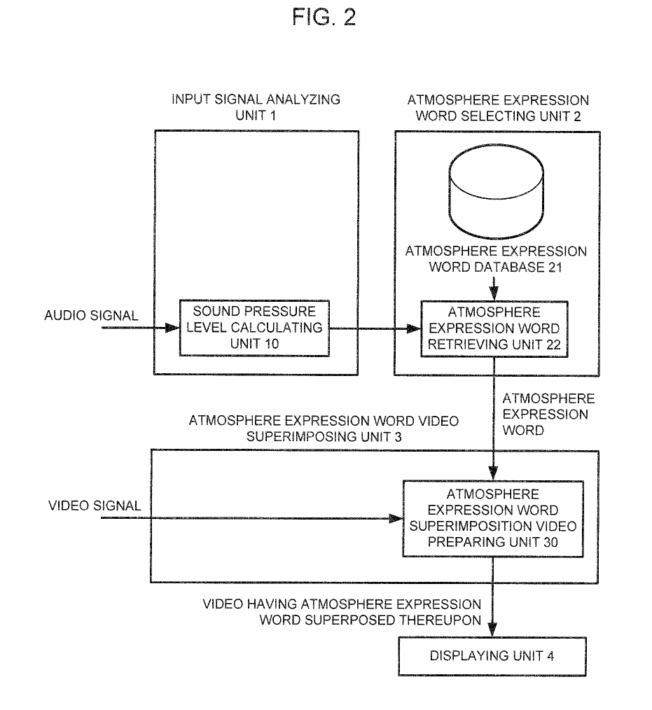

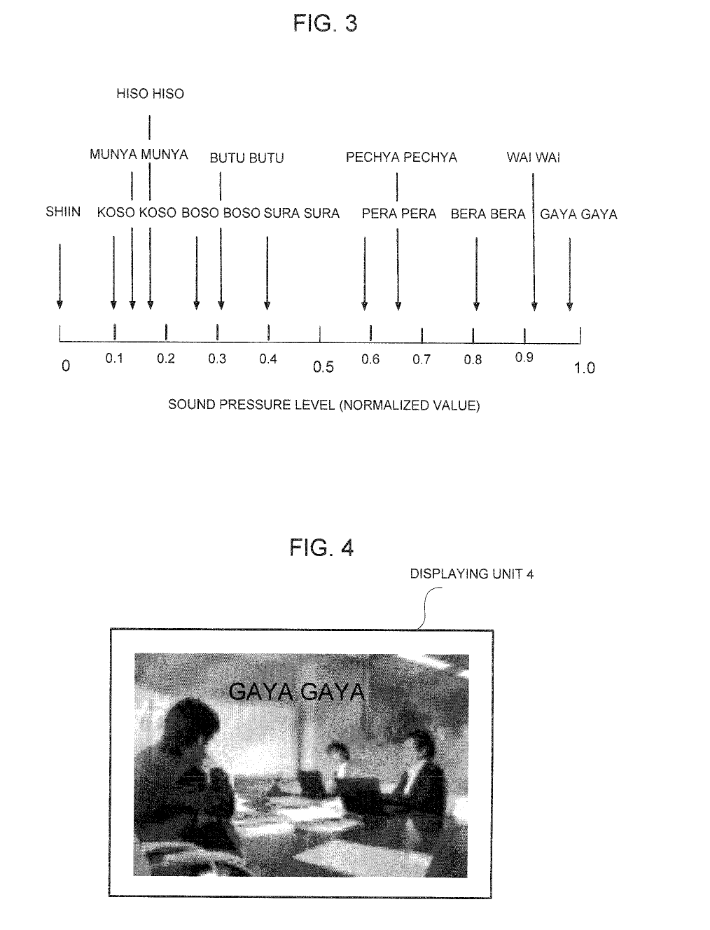

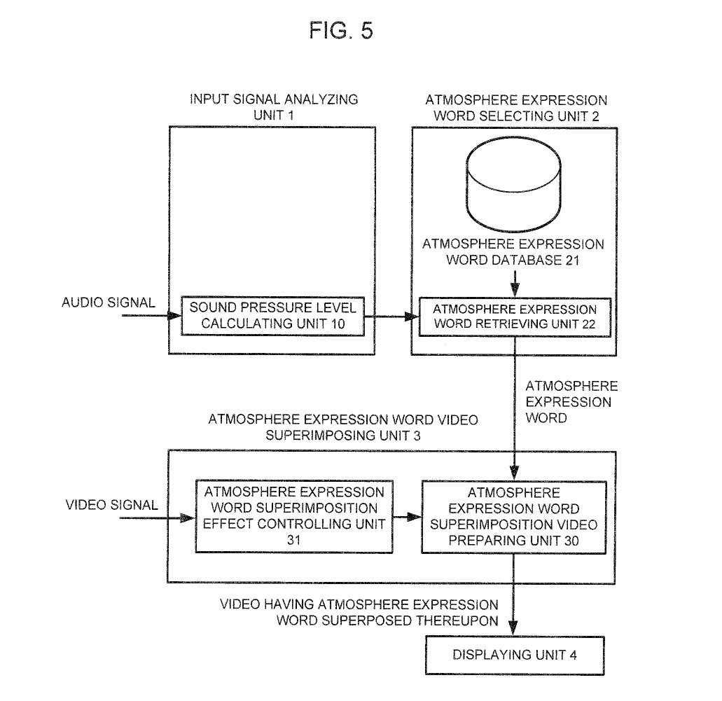

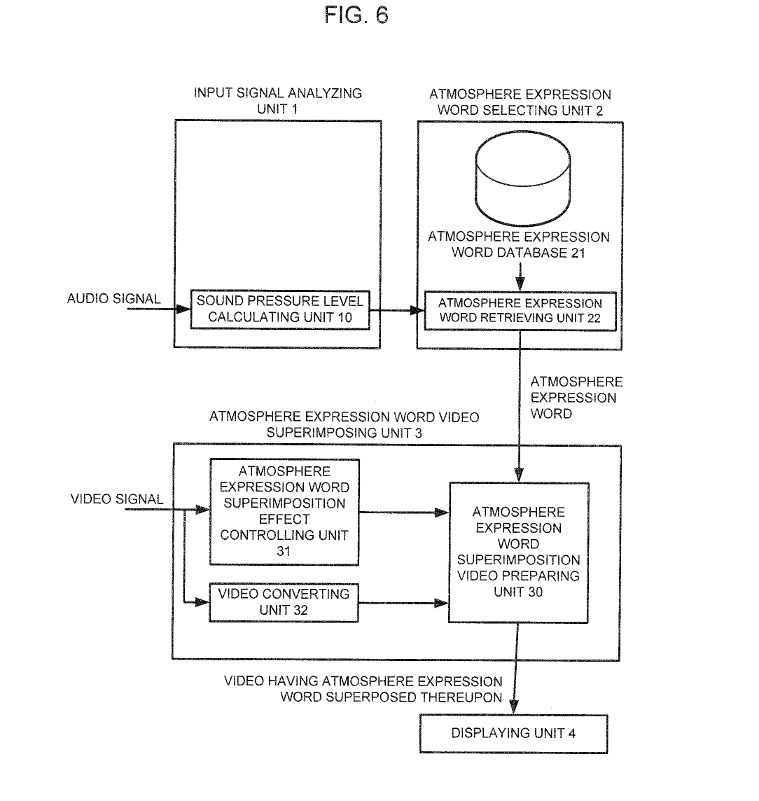

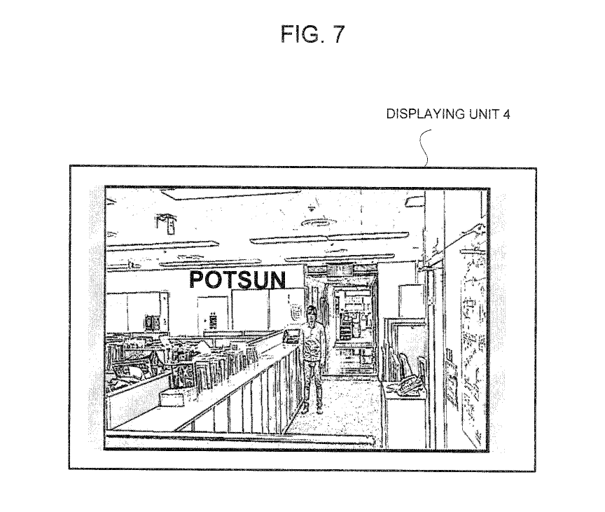

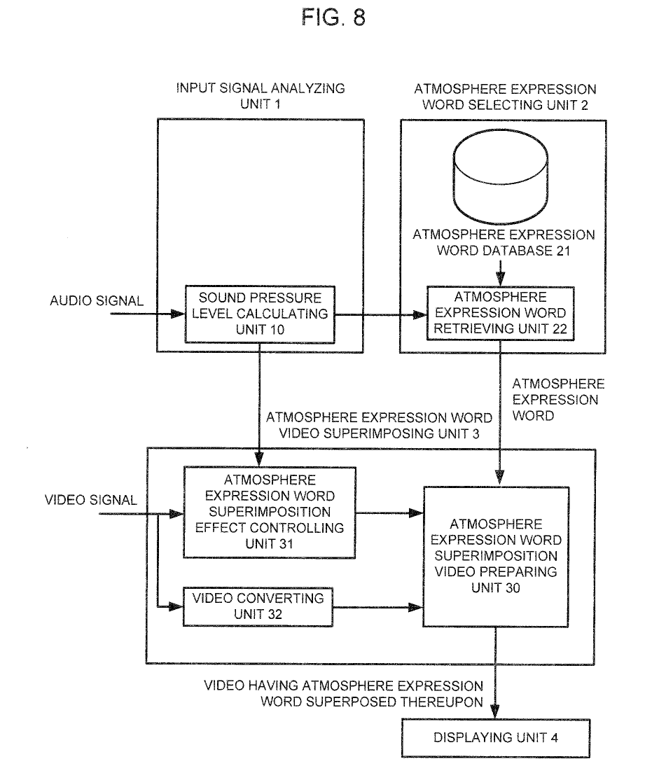

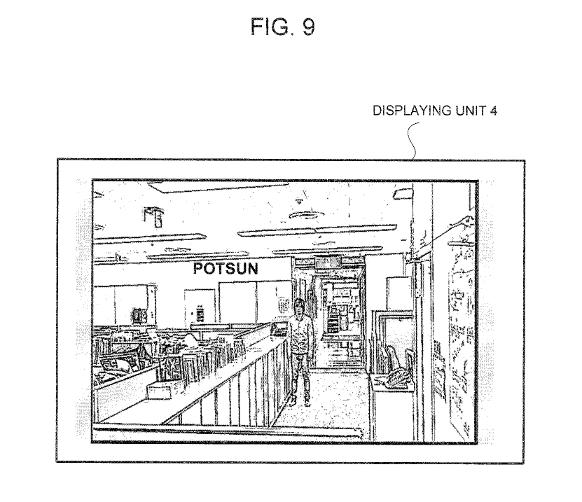

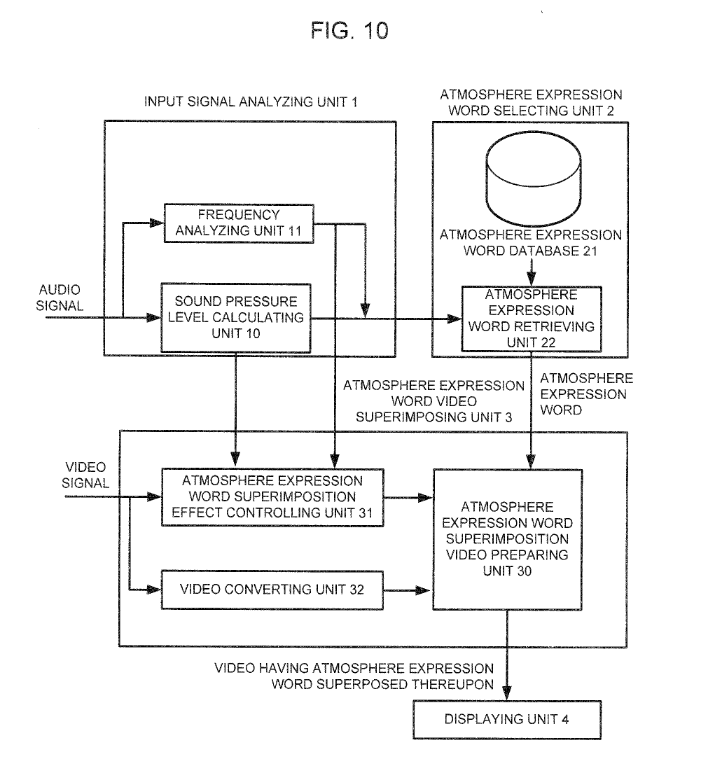

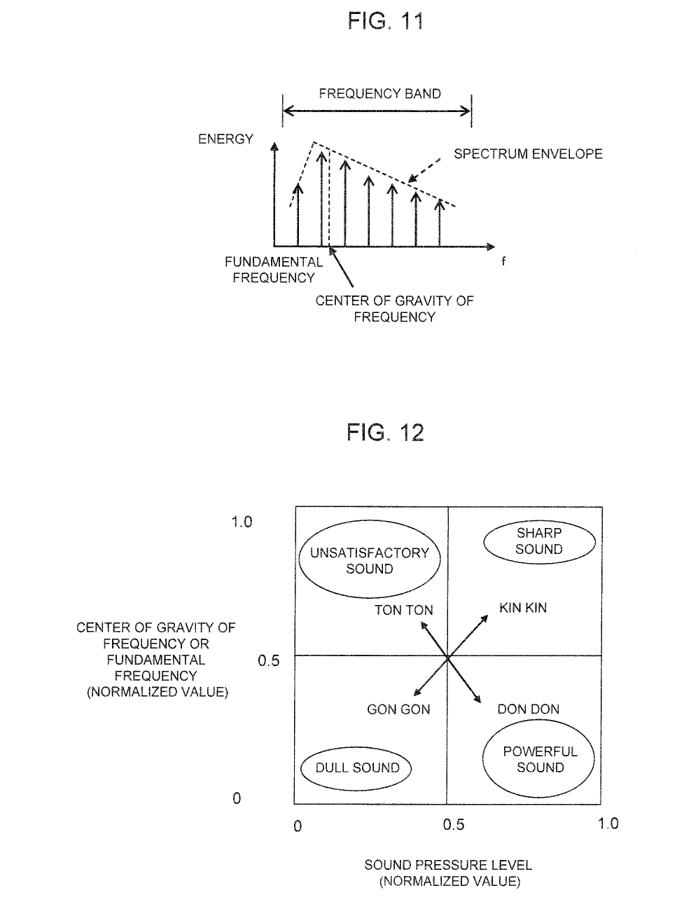

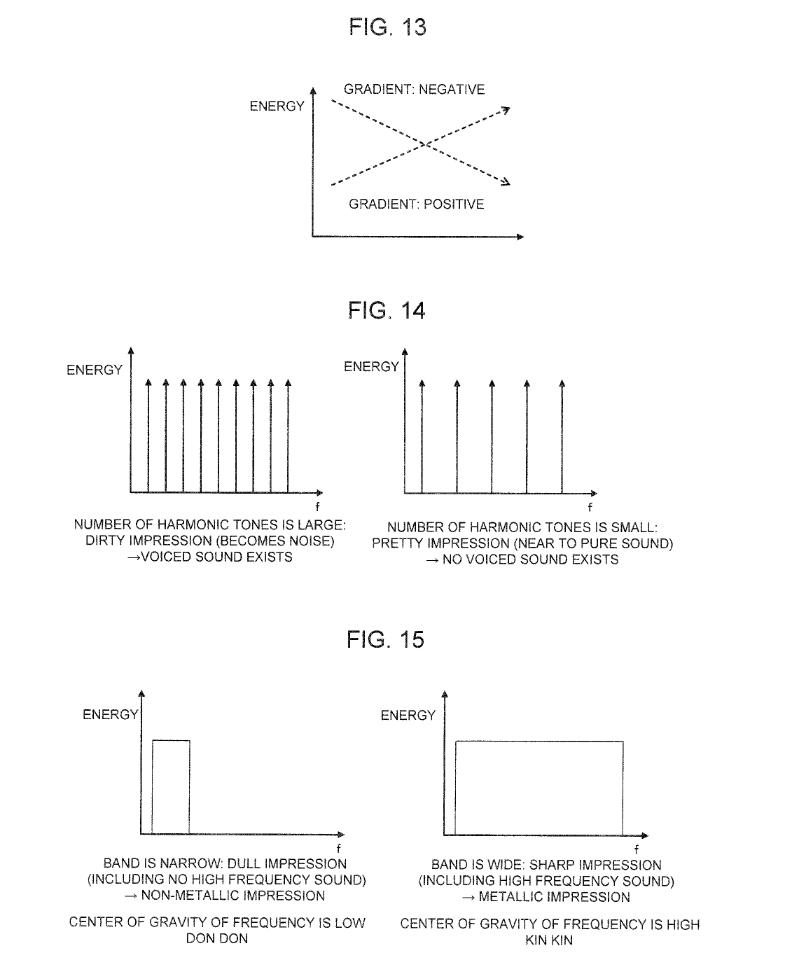

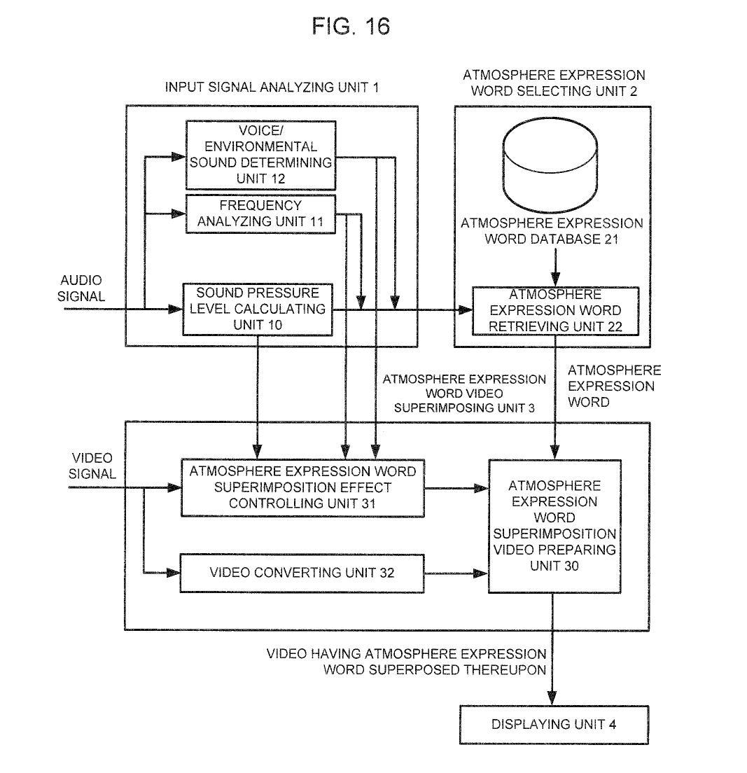

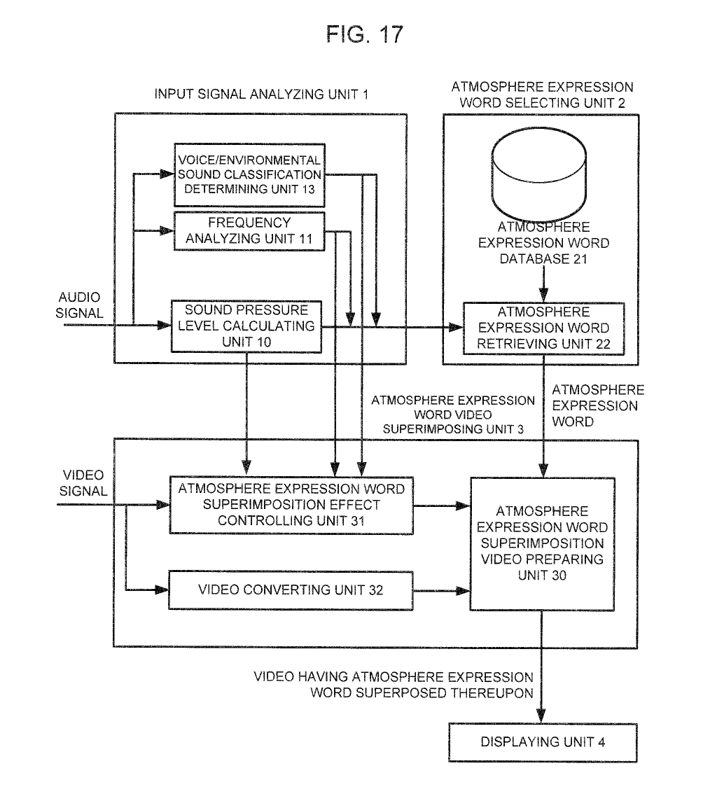

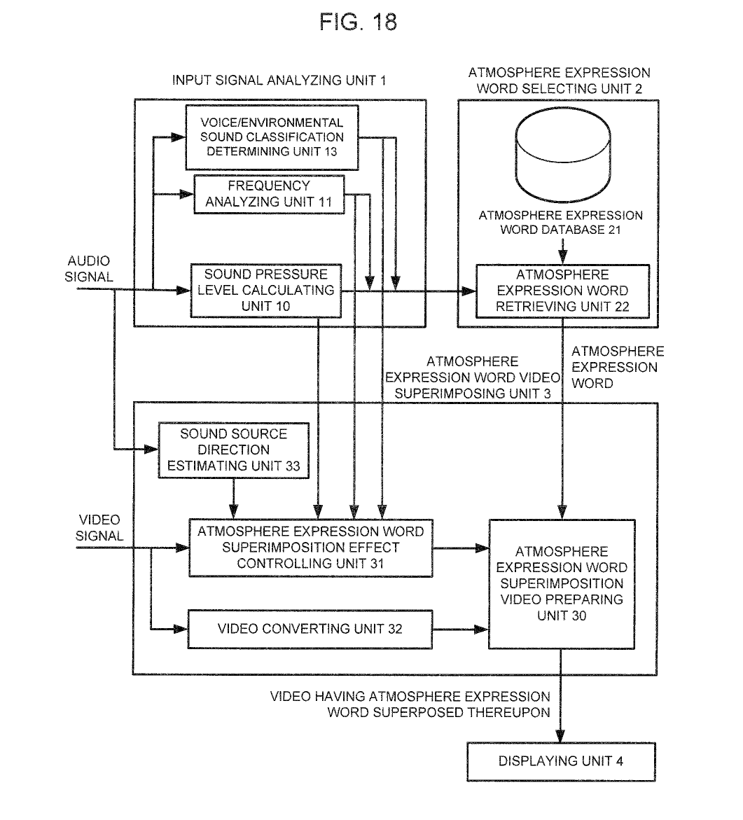

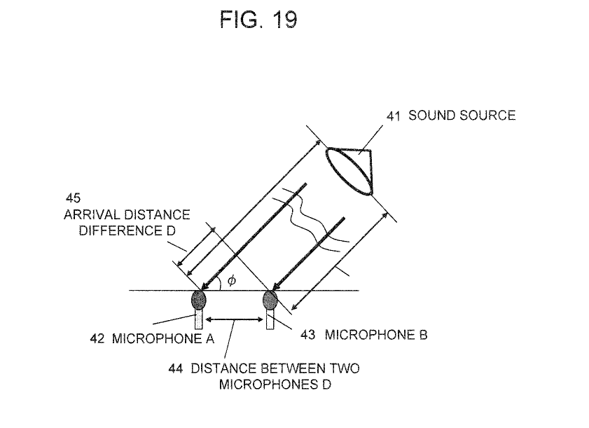

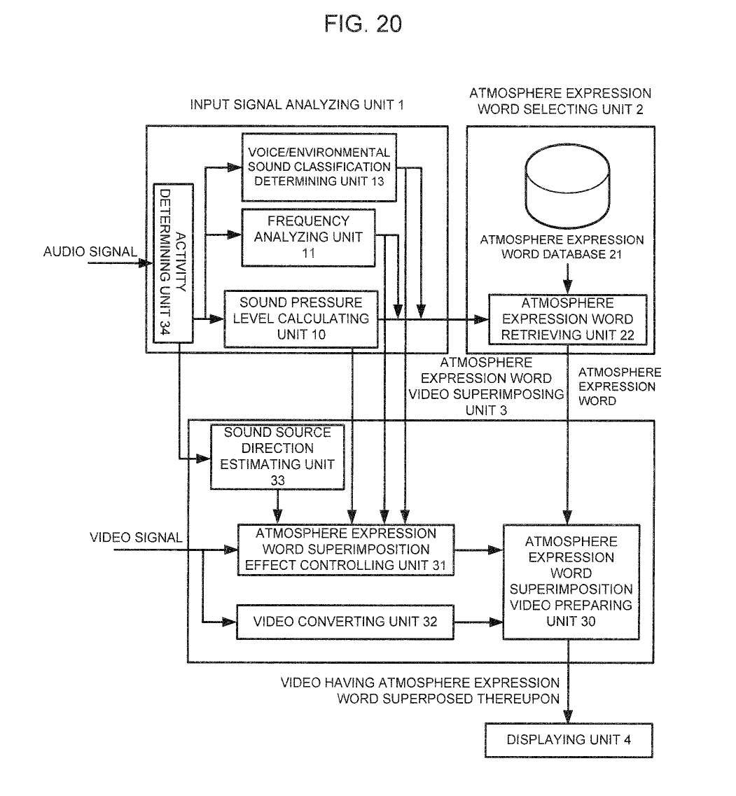

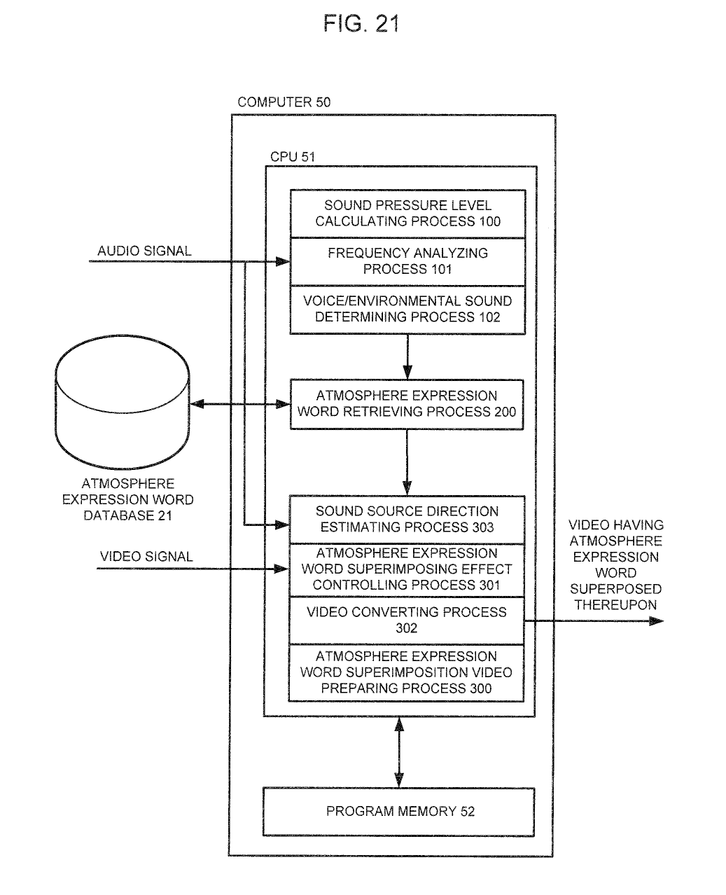

### BRIEF DESCRIPTION OF DRAWINGS

[FIG. 1] FIG. 1 is a block diagram of the information display system of this exemplary embodiment.

[FIG. 2] FIG. 2 is a block diagram of the information display system of a first exemplary embodiment.

[FIG. 3] FIG. 3 is a view illustrating one example of an atmosphere expression word database 21.

[FIG. 4] FIG. 4 is a view illustrating one example of the video having the atmosphere expression word superimposed thereupon.

[FIG. 5] FIG. 5 is a block diagram of the information display system of a second exemplary embodiment.

[FIG. 6] FIG. 6 is a block diagram of the information display system of a third exemplary embodiment.

[FIG. 7] FIG. 7 is a view illustrating one example of the video to be outputted by a displaying unit 4.

[FIG. 8] FIG. 8 is a block diagram of the information display system of a fourth exemplary embodiment.

[FIG. 9] FIG. 9 is a view illustrating one example of the video having the atmosphere expression word superimposed thereupon.

[FIG. 10] FIG. 10 is a block diagram of the information display system of a fifth exemplary embodiment.

[FIG. 11] FIG. 11 is a view for explaining frequency information.

[FIG. 12] FIG. 12 is a view illustrating one example of the atmosphere expression word database 21 having the atmosphere expression words mapped hereto in two dimensions of a sound pressure level (normalized value) and a center of gravity of a frequency (normalized value) in a case in which atmospheric sound information is the sound pressure level and the center of gravity of the frequency (normalized value).

[FIG. 13] FIG. 13 is a view for explaining the frequency information.

[FIG. 14] FIG. 14 is a view for explaining the frequency information.

[FIG. 15] FIG. 15 is a view for explaining the frequency information.

[FIG. 16] FIG. 16 is a block diagram of the information display system of a sixth exemplary embodiment.

[FIG. 17] FIG. 17 is a block diagram of the information display system of a seventh exemplary embodiment.

[FIG. 18] FIG. 18 is a block diagram of the information display system of an eighth exemplary embodiment.

[FIG. 19] FIG. 19 is a view for explaining the eighth exemplary embodiment.

[FIG. 20] FIG. 20 is a block diagram of the information display system of a ninth exemplary embodiment.

[FIG. 21] FIG. 21 is a block diagram of the information display system of a tenth exemplary embodiment.

### DESCRIPTION OF EMBODIMENTS

The exemplary embodiments of the present invention will be explained.

At first, an outline of the present invention will be explained.

FIG. 1 is a block diagram of the information display system of this exemplary embodiment.

As shown in FIG. 1, the information display system of this exemplary embodiment includes an input signal analyzing unit 1, an atmosphere expression word selecting unit 2, an atmosphere expression word video superimposing unit 3, and a displaying unit 4.

The input signal analyzing unit 1 inputs audio signals acquired in a certain predetermined field, analyzes the audio signals, and prepares atmospheric sound information related to the sound that is being generated in the above predetermined field (hereinafter, described as an atmospheric sound). The so-called atmospheric sound is various sounds that are being generated in the field in which the audio signals have been acquired, for example, a voice and a concept including the environmental sound other than the voice. The human being, who lives in the various sounds including the voice, feels atmosphere for the sound itself other than the meaning/content of the voice. For example, now think about a field in which many human beings are present, the sound of people's moving around, the sound of people's opening documents, and the like are generated even though all human beings do not utter the voice. In such a case, the human being feels that the above field is, for example, in a situation of “Gaya Gaya”. On the other hand, there is also a case in which no sound is generated at all even though many human beings are present, or a case in which the sound that is being generated is small (the audio signal sound pressure level is low). In such a case, the human being feels that the above field is in a situation of “Shiin”. In such a manner, the human being takes in various atmospheres from the sound (including the case of silence) that is felt in the above field.

Thereupon, the input signal analyzing unit 1 analyzes the audio signals of the atmospheric sound that is being generated in a predetermined field, analyzes which type of the atmospheric sound is being generated in the above field, and prepares the atmospheric sound information related to the atmospheric sound. Herein, the so-called atmospheric sound information is magnitude of the sound pressure of the audio signals, the frequency of the audio signals, the type of the audio signals (for example, a classification of the voice and the environmental sounds except the voice such as the sound of rain and the sound of an automobile) or the like.

The atmosphere expression word selecting unit 2 selects the atmosphere expression word corresponding to the atmospheric sound that is being generated in the field in which the audio signals have been acquired based on the atmospheric sound information prepared by the input signal analyzing unit 1. Herein, the so-called atmosphere expression word is a word expressing what the human being feels, for example, feeling, atmosphere and sense from the sound that is being generated in the field in which the audio signals have been acquired. As a representative word of the atmosphere expression word, there exist an onomatopoeic word and a mimetic word.

For example, when the atmospheric sound information is the sound pressure level of the audio signals, it is thinkable that the larger sound is being generated as the sound pressure level is higher, and it can be seen that the large sound is being generated in the field in which the audio signals have been acquired and the above field is noisy. Thereupon, the atmosphere expression word selecting unit 2 selects the atmosphere expression words “Zawa Zawa (onomatopoeia in Japanese)” and “Gaya Gaya”, being the onomatopoeic word or the mimetic word, from which the atmosphere of the above field can be taken in. Further, when it is thinkable that the sound pressure level is almost next to zero, and near to silence, the atmosphere expression word selecting unit 2 selects the atmosphere expression word “Shiin”, being the onomatopoeic word or the mimetic word, from which the atmosphere of the above field can be taken in.

Further, when the atmospheric sound information is the frequency of the audio signals, it is thinkable that the frequency of the audio signals is changed according to a sound source of the sound. Thereupon, the atmosphere expression word selecting unit 2 selects “Ddo Ddo (onomatopoeia in Japanese)” that reminds of noise of constructions or “Boon (onomatopoeia in Japanese)” that reminds of an exhaust sound of an automobile when the frequency of the audio signals is low, and selects the atmosphere expression word representing a metallic imagination such as “Kan Kan (onomatopoeia in Japanese)” or the atmosphere expression word of hitting trees such as “Kon Kon (onomatopoeia in Japanese)” when, on the contrary, the frequency of the audio signals is high.

In addition, when the classification of the audio signals is employed as the atmospheric sound information, the atmosphere expression word selecting unit 2 selects the more accurate atmosphere expression word according to the classification of the sound that is being generated in the above field. For example, the atmosphere expression word selecting unit 2 can select “Ddo Ddo” or “Boon” by distinguishing the sound of a drill used in the construction from the exhaust sound of the automobile.

The atmosphere expression words selected in such a manner are outputted to the atmosphere expression word video superimposing unit 3 according to the outputting of text data etc.

The atmosphere expression word video superimposing unit 3 inputs the video signals of the video obtained from the field in which the atmospheric sound has been acquired, and superimposes the atmosphere expression word selected by the atmosphere expression word selecting unit 2 upon the video of the above field. The followings are thinkable as a method of superimposing the atmosphere expression words upon the video.

(1) The atmosphere expression word video superimposing unit 3 superimposes the selected atmosphere expression word at a predetermined position of the original video.

(2) The atmosphere expression word video superimposing unit 3 superimposes the selected atmosphere expression word by changing a shape of the atmosphere expression word (for example, a type of a font and magnitude of a font size), a character color, a superimposition position and the like based on the sound pressure level of the atmospheric sound, the frequency information, an arrival direction of the sound and the like.

(3) The atmosphere expression word video superimposing unit 3 detects a region in which the movement is large, out of the video, and superimposes the selected atmosphere expression word in the neighborhood of the above region.

(4) The atmosphere expression word video superimposing unit 3 detects a region in which a change in a color is small, a region in which a change in luminance is small, and a region in which a change in an edge are small, out of the video, and superimposes the selected atmosphere expression words in the above region.

Further, with regard to the videos to be superimposed, the atmosphere expression word may be superimposed upon not only the original video but also other videos such as a sketchy video obtained by converting the original video.

The video having the atmosphere expression word superposed thereupon in such a manner is outputted to the displaying unit 4.

The displaying unit 4 displays the video having the atmosphere expression word superimposed thereupon.

This, as compared with the conventional technology that, so far, pays attention to reappearance of the faithful sound field and video in order to obtain a sense of presence, namely, the atmosphere of the above field and the mutual situations, allows the atmosphere to be more easily shared mutually by more clearly expressing the atmosphere of the above field and mutual situations with the video having the atmosphere expression word appealing to the human being's sensitivity superimposed thereupon, thereby making it possible to obtain a sense of presence that have not been obtained so far.

Hereinafter, specific exemplary embodiments will be explained.

### First Exemplary Embodiment

The first exemplary embodiment will be explained.

The first exemplary embodiment prepares the atmospheric sound information by paying attention to magnitude of the sound of the audio signals acquired from the atmospheric sound that is being generated at a certain predetermined field. And, an example of selecting the atmosphere expression word (the onomatopoeic word and the mimetic word) suitable for the field in which the audio signals have been acquired based on the atmospheric sound information will be explained.

FIG. 2 is a block diagram of the information display system of the first exemplary embodiment.

The information display system of the first exemplary embodiment includes an input signal analyzing unit 1, an atmosphere expression word selecting unit 2, an atmosphere expression word video superimposing unit 3, and a displaying unit 4.

The input signal analyzing unit 1 includes a sound pressure level calculating unit 10. The sound pressure level calculating unit 10 calculates the sound pressure of the audio signals of the inputted atmospheric sound, and outputs a value (0 to 1.0) obtained by normalizing the sound pressure level as the atmospheric sound information to the atmosphere expression word selecting unit 2.

The atmosphere expression word selecting unit 2 includes an atmosphere expression word database 21 and an atmosphere expression word retrieving unit 22.

The atmosphere expression word database 21 is a database having the atmosphere expression words corresponding to the value (0 to 1.0) of the atmospheric sound information stored therein. One example of the atmosphere expression word database 21 is shown in FIG. 3.

The atmosphere expression word database 21 shown in FIG. 3 shows the values of the atmospheric sound information (the sound pressure level: 0 to 1.0) and the atmosphere expression words (for example, the onomatopoeic words and the mimetic words) corresponding hereto, and for example, the atmosphere expression word in a case in which the value of the atmospheric sound information is “0.0” is “Shiin” and the atmosphere expression word in a case in which the value of the atmospheric sound information is “0.1” is “Koso Koso (mimetic word in Japanese)”. Further, the atmosphere expression word in a case in which the value of the atmospheric sound information is “0.9 or more and less than 0.95” is “Wai Wai (onomatopoeia in Japanese)”, and the atmosphere expression word in a case in which the value of the atmospheric sound information is “0.95 or more and 1 or less” is “Gaya Gaya”. In such a manner, the atmosphere expression words corresponding to the values of the atmospheric sound information are stored.

The atmosphere expression word retrieving unit 22 inputs the atmospheric sound information from the input signal analyzing unit 1, and retrieves the atmosphere expression word corresponding to this atmospheric sound information from the atmosphere expression word database 21. For example, when the value of the atmospheric sound information obtained from the input signal analyzing unit 1 is “0.64”, the atmosphere expression word retrieving unit 22 selects the atmosphere expression word corresponding to “0.64” from the atmosphere expression word database 21. In an example of the atmosphere expression word database 21 shown in FIG. 3, the atmosphere expression word corresponding to “0.64” is “Pechya Pechya (onomatopoeia in Japanese)” existing between 0.6 and 0.7. Thus, the atmosphere expression word retrieving unit 22 retrieves “Pechya Pechya” as the atmosphere expression word corresponding to the value of the atmospheric sound information “0.64”. The retrieved atmosphere expression word is outputted to the atmosphere expression word video superimposing unit 3 in a format of the text data etc.

The atmosphere expression word video superimposing unit 3 includes an atmosphere expression word superimposition video preparing unit 30.

The atmosphere expression word superimposition video preparing unit 30 prepares an atmosphere expression word superimposition video by superimposing the retrieved atmosphere expression word at a predetermined superimposition position of the video with a predetermined type of the font, font size, and character color. And, the atmosphere expression word superimposition video preparing unit 30 outputs the prepared atmosphere expression word superimposition video to the displaying unit 4.

The displaying unit 4 inputs the prepared atmosphere expression word superimposition video from the atmosphere expression word video superimposing unit 3, and displays the video having the atmosphere expression word superimposed thereupon.

One example of the video having the atmosphere expression word superimposed thereupon is shown in FIG. 4. In an example shown in FIG. 4, the atmosphere expression word “Gaya Gaya” selected based on the atmospheric sound acquired in the field of a conference is superimposed upon the video captured in the field of the conference.

As mentioned above, the first exemplary embodiment is configured to select the atmosphere expression word (the onomatopoeic word and the mimetic word) expressing the atmosphere and the mutual situations corresponding to magnitude of the sound of the above field, which appeals to the human being's sensitivity, and to superimpose its selected atmosphere expression word upon the video of the above field. Making such a configuration allows the atmosphere to be easily shared mutually by more clearly representing the atmosphere of the above field and the mutual situations not only with visualization but also with the video having the atmosphere expression word appealing to the human being's sensitivity superimposed thereupon, thereby making it possible to obtain a sense of presence that have not been obtained so far.

### Second Exemplary Embodiment

The second exemplary embodiment will be explained.

In the second exemplary embodiment, an example of analyzing the video upon which the atmosphere expression word is superimposed, and effectively displaying the atmosphere expression word to be superimposed will be explained.

FIG. 5 is a block diagram of the information display system of the second exemplary embodiment. Additionally, identical codes are affixed to the parts identical to the first exemplary embodiment, so detailed explanation is omitted.

The atmosphere expression word video superimposing unit 3 includes an atmosphere expression word superimposition effect controlling unit 31 besides the components of the first exemplary embodiment.

The atmosphere expression word superimposition effect controlling unit 31 analyzes the inputted video signals, specifies, for example, a region in which the movement of the video is large, and outputs information indicating the above region to the atmosphere expression word superimposition video preparing unit 30.

The atmosphere expression word superimposition video preparing unit 30 superimposes the retrieved atmosphere expression word in the region obtained by the atmosphere expression word superimposition effect controlling unit 31 in which the movement is large, and prepares the atmosphere expression word superimposition video. And, the atmosphere expression word superimposition video preparing unit 30 outputs the atmosphere expression word superimposition video to the displaying unit 4.

Detecting the region in which the movement is large and superimposing the atmosphere expression word in the neighborhood of this region in such a manner makes it possible to effectively arrange the atmosphere expression word in a position in which the sound is estimated to be being generated.

Additionally, the atmosphere expression word superimposition effect controlling unit 31 may not only detect the region in which the movement is large but also specify the movement of a certain object. For example, the atmosphere expression word superimposition effect controlling unit 31 detects the movement of the automobile in the video having the automobile captured therein. And, the atmosphere expression word superimposition effect controlling unit 31 outputs information of this movement to the atmosphere expression word superimposition video preparing unit 30. The atmosphere expression word superimposition video preparing unit 30 may superimpose the atmosphere expression word “Boon”, being the engine sound of the automobile selected by the atmosphere expression word selecting unit 2, upon the video according to the movement of the automobile.

Further, the atmosphere expression word superimposition effect controlling unit 31 may detect not only the region in which the movement is large but also the region in which a change in the color is small, the region in which a change in the luminance is small, and the region in which a change in the edge is small. For example, the atmosphere expression word superimposition effect controlling unit 31 detects the region of walls of the building or the region of the sky in the video having the street captured therein. And, the atmosphere expression word superimposition effect controlling unit 31 outputs information indicating this region to the atmosphere expression word superimposition video preparing unit 30. The atmosphere expression word superimposition video preparing unit 30 may superimpose the retrieved atmosphere expression word in this region. With this, the atmosphere expression word and other objects in the video hardly overlap each other, and the atmosphere expression word can be effectively arranged.

In addition, the atmosphere expression word superimposition effect controlling unit 31 may appropriately change the type of the font, the magnitude of the size, and the color of the atmosphere expression word to be superimposed by analyzing the video. For example, the atmosphere expression word superimposition effect controlling unit 31 may analyze the region size of the object in the video to make the font size large in the large region and to make the font size small in the small region

As mentioned above, the second exemplary embodiment analyzes the video signals and appropriately changes the position in which atmosphere expression word is superimposed, its font, its font size, and its color, whereby the atmosphere of the above field and the mutual situations are easily shared all the more, and a sense of presence that have not been obtained so far can be obtained.

### Third Exemplary Embodiment

The third exemplary embodiment will be explained.

In the third exemplary embodiment, an example of converting the original video captured in the field in which the atmospheric sound has been acquired into the sketchy video by performing a predetermined process for it, and superimposing the selected atmosphere expression word upon the sketchy video obtained by changing the original video will be explained.

FIG. 6 is a block diagram of the information display system of the third exemplary embodiment. Additionally, identical codes are affixed to the parts identical to the first exemplary embodiment and the second exemplary embodiment, so detailed explanation is omitted.

The atmosphere expression word video superimposing unit 3 includes a video converting unit 32 besides the components of the second exemplary embodiment.

The video converting unit 32 converts the color video of the inputted video signals into the video of the vivid sketchy image. As a method of converting into the vivid sketchy video image that is performed by the video converting unit 32, for example, the technology described in Patent literature WO 2006/106750 may be employed.

This image processing method is characterized in including a first color conversion step of converting the component of the image data on the color image expressed in an arbitrary color space into a brightness component and a chromaticity component in a color space in which the chromaticity does not vary even though the brightness varies or in a color space in which the chromaticity does not converge to one point when the brightness is maximized, a filtering step of performing a space filtering for the brightness component acquired by the aforementioned first color conversion step, and a second color conversion step of converting the brightness component subjected to the aforementioned space filtering and the chromaticity component acquired by the aforementioned first color conversion step into the aforementioned component of the image data of the color image.

Such a method prevents the chromaticity from converging to one point according to a change in the brightness even though the brightness component is subjected to the space filtering because the component of the image data on the color image expressed in an arbitrary color space is converted into the brightness component and the chromaticity component in a color space in which the chromaticity does not vary even though the brightness varies or in a color space in which the chromaticity does not converge to one point when the brightness is maximized in the first color conversion step. Thus, it becomes unnecessary to adjust the vividness with a manual operation.

For example, the method may be employed of converting an RGB component of the image data of the color image expressed in RGB into the brightness component and the chromaticity component in an HSV color space in the first color conversion step, and converting the brightness component subjected to the space filtering and the chromaticity component acquired by the aforementioned first color conversion step into the RGB component in the second color conversion step.

For example, the method may be employed of performing the space filtering by subjecting the brightness component to a convolution operation that, in a case in which kernel is defined as f(i,j) in the filtering step, satisfies f(i,j)>0 when at least each of i and j is a value near to the intermediate value of the attainable maximum value and the attainable minimum value of each of i and j, satisfies f(i,j)<0 when at least one of i and j is the maximum value thereof or the minimum value thereof, and satisfies the condition that a sum of f(i,j) responding to each of i and j is positive.

Such a method makes it possible to realize the conversion such that a fine change in a shadow of the picture image etc. is not reflected, together with the preparation of a contour by emphasizing a change in the brightness, and to convert the image data of the color image into image data indicating the vivid sketchy image without a manual operation.

Further, this image processing method is characterized in including a first color conversion step of converting the component of the image data on the color image expressed in an arbitrary color space into a brightness component, a saturation component, and a hue component in a color space in which the saturation and the hue do not vary even though the brightness varies or in a color space in which the saturation and the hue do not converge to one point when the brightness is maximized, a filtering step of performing a space filtering for the brightness component acquired by the conversion in the aforementioned first color conversion step, an emphasis processing step of performing an emphasis process, which prevents the value of the saturation from being changed, or makes a change to a larger value responding to the value of the saturation, for the saturation component acquired by the conversion in the aforementioned first color conversion step, and a second color conversion step of converting the brightness component subjected to the aforementioned space filtering, the saturation component subjected to the aforementioned emphasis process, and the hue component acquired by the conversion in the aforementioned first color conversion step into the aforementioned component of the image data of the color image.

Such a method prevents the saturation and the hue from converging to one point according to a change in the brightness even though the brightness component is subjected to the space filtering because the component of the image data on the color image expressed in an arbitrary color space is converted into the brightness component, the saturation component, and the hue component in a color space in which the saturation and the hue do not vary even though the brightness varies or in a color space in which the saturation and the hue do not converge to one point when the brightness is maximized in the first color conversion step. Thus, it becomes unnecessary to adjust the vividness with a manual operation.

For example, the method may be employed of converting an RGB component of the image data of the color image expressed in RGB into a brightness component, a saturation component, and a hue component in an HSV color space in the first color conversion step, and converting the brightness component subjected to the space filtering, the saturation component subjected to the emphasis process, and the hue component acquired by the conversion in the aforementioned first color conversion step into the RGB component in the second color conversion step.

For example, the method may be employed of performing the space filtering by subjecting the brightness component to a convolution operation that, in a case in which kernel is defined as f(i,j) in the filtering step, satisfies f(i,j)>0 when at least each of i and j is a value near to the intermediate value of the attainable maximum value and the attainable minimum value of each of i and j, satisfies f(i,j)<0 when at least one of i and j is the maximum value thereof or the minimum value thereof, and satisfies the condition that a sum of f(i,j) responding to each of i and j is positive.

Such a method makes it possible to realize the conversion such that a fine change in a shadow of the picture image etc. is not reflected together with the preparation of a contour by emphasizing a change in the brightness, and to convert the color video into the vivid sketchy video without a manual operation.

Further, the method may be employed of not changing the value of the saturation when the value of the saturation is less than a predetermined threshold, and changing the value of the saturation to an attainable maximum value of the saturation, or a value near to the above maximum value when the value of the saturation exceeds the aforementioned threshold in the emphasis processing step.

Such a method makes it possible to convert the color video into a video having a very vivid color like paintings that children depict.

The method may be employed of defining the value, which is governed by a function having the value of the saturation as a variable, as a value of the saturation in the emphasis processing step.

The atmosphere expression word superimposition effect controlling unit 31 analyzes the inputted video signals (original video), specifies, for example, a position in which the movement of the video is violent, and outputs information indicating the above position to the atmosphere expression word superimposition video preparing unit 30.

The atmosphere expression word superimposition video preparing unit 30 superimposes the retrieved atmosphere expression word upon the video obtained by sketchily converting the original video coming from the video converting unit 32 in the position obtained from the atmosphere expression word superimposition effect controlling unit 31 in which the movement of the video is violent, and prepares the atmosphere expression word superimposition video. And, the atmosphere expression word superimposition video preparing unit 30 outputs the atmosphere expression word superimposition video to the displaying unit 4.

FIG. 7 shows one example of the video to be outputted to the displaying unit 4. FIG. 7 shows one example of converting the original video having a color into the sketchy video, and superimposing the atmosphere expression word upon this sketchy video.

As mentioned above, in the third exemplary embodiment, converting the original video into the sketchy video makes it possible to emphasis-display the video of the field in which the video signals have been acquired, and superimposing the selected atmosphere expression word upon this emphasis-displayed sketchy video allows the atmosphere of the above field and the mutual situations to be easily shared all the more, thereby making it possible to obtain a sense of presence that have not been obtained so far.

### Fourth Exemplary Embodiment

The fourth exemplary embodiment will be explained.

In the fourth exemplary embodiment, an example of paying attention to magnitude of the sound of the audio signals acquired from the atmospheric sound that is being generated in a certain predetermined field and changing the display effect of the selected atmosphere expression word will be explained.

FIG. 8 is a block diagram of the information display system of the fourth exemplary embodiment. Additionally, identical codes are affixed to the parts identical to the first, the second, and the third exemplary embodiments, so detailed explanation is omitted.

The atmosphere expression word superimposition effect controlling unit 31 receives the atmospheric sound information (a value (0 to 1.0) obtained by normalizing the sound pressure level of the audio signals of the atmospheric sound) coming from the sound pressure level calculating unit 10 of the input signal analyzing unit 1 as an input, and decides size of the font of the atmosphere expression word corresponding to this value of the atmospheric sound information. Specifically, the atmosphere expression word superimposition effect controlling unit 31 takes a control of enlarging the font size of the atmosphere expression word in proportion to magnitude of the value of the atmospheric sound information. And, the atmosphere expression word superimposition effect controlling unit 31 outputs the font size corresponding to magnitude of the value of the atmospheric sound information to the atmosphere expression word superimposition video preparing unit 30.

The atmosphere expression word superimposition video preparing unit 30 superimposes the atmosphere expression word retrieved by the atmosphere expression word retrieving unit 22 upon the video with the font size designated by the atmosphere expression word superimposition effect controlling unit 31, and prepares the atmosphere expression word superimposition video.

The displaying unit 4 inputs the atmosphere expression word superimposition video from the atmosphere expression word superimposition video preparing unit 30, and displays the video having the atmosphere expression word superimposed thereupon.

One example of the video having the atmosphere expression word superimposed thereupon is shown in FIG. 9. The example shown in FIG. 9 indicates one example of superimposing the atmosphere expression word, of which the font size has been made small because the sound pressure level is low.

As mentioned above, the fourth exemplary embodiment pays attention to magnitude of the sound of the audio signals and decides the font size of the atmosphere expression word, whereby the atmosphere of the above field and the mutual situations are easily shared all the more, depending on a change in a magnitude ratio of the atmosphere expression word that occupies the video, thereby making it possible to obtain a sense of presence that have not been obtained so far.

### Fifth Exemplary Embodiment

The fifth exemplary embodiment will be explained.

The fifth exemplary embodiment is configured to frequency-analyze the audio signals acquired from the atmospheric sound that is being generated in a certain predetermined field, and to prepare the atmospheric sound information by paying attention to magnitude of the sound and a frequency spectrum, besides the configurations of the above-described exemplary embodiments. And, an example of selecting the atmosphere expression word suitable for the field in which the audio signals have been acquired based on the atmospheric sound information, and together therewith, changing the display of the above atmosphere expression word will be explained.

FIG. 10 is a block diagram of the information display system of the fifth exemplary embodiment.

The input signal analyzing unit 1 includes a frequency analyzing unit 11 besides the components of the first exemplary embodiment.

The frequency analyzing unit 11 calculates frequency information representing features over the frequency of the sound such as a fundamental frequency of the input signals, a center of gravity of the frequency, a frequency band, a gradient of a spectrum envelop, and a number of harmonic tones.

A conceptual view of each item is shown in FIG. 11.

Herein, the so-called fundamental frequency, which is a frequency representing a pitch of the periodical sound, is governed by an oscillation period of the sound, and the pitch of the sound is high when the oscillation period of the sound is short and the pitch of the sound is low when the oscillation period of the sound is long. Further, the so-called center of gravity of the frequency, which is a weighted average of the frequency with an energy defined as a weight, represents the pitch of the sound with noise. Further, the so-called frequency band is an attainable band of the frequency of the inputted audio signals. Further, the so-called spectrum envelope represents a rough tendency of the spectrum, and its gradient exerts an influence upon a tone.

The frequency analyzing unit 11 outputs the frequency information as mentioned above as the atmospheric sound information.

The atmosphere expression word retrieving unit 22 inputs the sound pressure level and the frequency information as the atmospheric sound information, and selects the atmosphere expression word corresponding to the atmospheric sound information from the atmosphere expression word database 21. For this reason, not only the sound pressure level but also the atmosphere expression word corresponding to the atmospheric sound information that has been learned in consideration of the frequency information as well is stored in the atmosphere expression word database 21. Further, the atmosphere expression word retrieving unit 22 inputs the sound pressure level and the frequency information as the atmospheric sound information, and selects the atmosphere expression word suitable for the sound pressure level and the frequency information from the atmosphere expression word database 21.

The atmosphere expression word superimposition effect controlling unit 31 inputs the sound pressure level and the frequency information as the atmospheric sound information, and controls a display effect of the atmosphere expression word based on the atmospheric sound information.

One example of retrieving the atmosphere expression word by the atmosphere expression word retrieving unit 22 and controlling the display effect by the atmosphere expression word superimposition effect controlling unit 31 will be explained.

FIG. 12 is a view illustrating one example of the atmosphere expression word database 21 having the atmosphere expression words mapped hereto in two dimensions of the sound pressure level (normalized value) and the center of gravity of the frequency (normalized value) in a case in which the atmospheric sound information is the sound pressure level and the center of gravity of the frequency (normalized value).

The atmosphere expression word retrieving unit 22, upon receipt of, for example, the atmospheric sound information of which the value of the sound pressure level and the value of the center of gravity of the frequency are large and small, respectively, judges that a powerful sound is being generated in the field in which the audio signals have been acquired, and selects the atmosphere expression word “Don Don”. On the other hand, the atmosphere expression word retrieving unit 22, upon receipt of the atmospheric sound information of which the value of the sound pressure level and the value of the center of gravity of the frequency are small and large, respectively, judges that an unsatisfactory sound is being generated in the field in which the audio signals have been acquired, and selects the atmosphere expression word “Ton Ton”. Further, the atmosphere expression word retrieving unit 22, upon receipt of the atmospheric sound information of which not only the value of the sound pressure level and but also the value of the center of gravity of the frequency is large, judges that a sharp sound is being generated in the field in which the audio signals have been acquired, and selects the atmosphere expression word “Kin Kin”. On the other hand, the atmosphere expression word retrieving unit 22, upon receipt of the atmospheric sound information of which not only the value of the sound pressure level and but also the value of the center of gravity of the frequency is small, judges that a dull sound is being generated in the field in which the audio signals have been acquired, and selects the atmosphere expression word “Gon Gon (onomatopoeia in Japanese)”, Additionally, the situation is similar with the fundamental frequency instead of the center of gravity of the frequency.

Further, the atmosphere expression word superimposition effect controlling unit 31, upon receipt of the atmospheric sound information of which the value of the sound pressure level and the value of the center of gravity of the frequency are large and small, respectively, judges that the powerful sound is being generated in the field in which the audio signals have been acquired, and selects the rounded boldface font with large size as a font for displaying the atmosphere expression word “Don Don”. On the other hand, the atmosphere expression word superimposition effect controlling unit 31, upon receipt of the atmospheric sound information of which the value of the sound pressure level and the value of the center of gravity of the frequency are small and large, respectively, judges that the unsatisfactory sound is being generated in the field in which the audio signals have been acquired, and selects the thin-character font with small size as a font for displaying the atmosphere expression word “Ton Ton”. Further, the atmosphere expression word superimposition effect controlling unit 31, upon receipt of the atmospheric sound information of which not only the value of the sound pressure level but also the value of the center of gravity of the frequency is large, judges that the sharp sound is being generated in the field in which the audio signals have been acquired, and selects the harsh thin-character font with large size as a font for displaying the atmosphere expression word “Kin Kin”. On the other hand, the atmosphere expression word superimposition effect controlling unit 31, upon receipt of the atmospheric sound information of which not only the value of the sound pressure level but also the value of the center of gravity of the frequency is small, judges that the dull sound is being generated in the field in which the audio signals have been acquired, and selects the rounded thin-character font with small size as a font for displaying the atmosphere expression word “Gon Gon”.

While an example of selecting the atmosphere expression word in terms of the sound pressure level, and the center of gravity of the frequency or the fundamental frequency was shown in the above description, the selection of the atmosphere expression word is not limited hereto. For example, as shown in FIG. 13, the atmosphere expression word retrieving unit 22 may select the atmosphere expression word corresponding to the sound pressure level from among the atmosphere expression words with a voiced sound as the atmosphere expression word having a dull impression when the frequency information is a gradient of the spectrum envelope and its gradient is negative, and may select the atmosphere expression word corresponding to the sound pressure level from among the atmosphere expression words with no voiced sound as the atmosphere expression word having a sharp impression when the gradient is positive.

Further, the atmosphere expression word superimposition effect controlling unit 31 may select the font with size corresponding to the sound pressure level from among the rounded fonts as a font for displaying the atmosphere expression word having a dull impression when the frequency information is a gradient of the spectrum envelope and its gradient is negative, and may select the font with size corresponding to the sound pressure level from among the harsh fonts as a font for displaying the atmosphere expression word having a sharp impression when the gradient is positive.

Further, for example, as shown in FIG. 14, the atmosphere expression word retrieving unit 22 may select the atmosphere expression word corresponding to the sound pressure level from among the atmosphere expression words with a voiced sound, which gives a dirty impression (becomes noise), when the frequency information is the number of harmonic tones and its number is large, and may select the atmosphere expression word corresponding to the sound pressure level from among the atmosphere expression words with no voiced sound, which gives a pretty impression (near to a pure sound), when its number is small.

On the other hand, the atmosphere expression word superimposition effect controlling unit 31 may select the font with size corresponding to the sound pressure level from among the shape-collapsed fonts as a font for displaying the atmosphere expression word with a voiced sound, which gives a dirty impression (becomes noise), when the frequency information is the number of harmonic tones and its number is large, and may select the font with size corresponding to the sound pressure level from among the well-trimmed fonts as a font for displaying the atmosphere expression word with no voiced sound, which gives a pretty impression (near to a pure sound), when its number is small.

In addition, for example, as shown in FIG. 15, the atmosphere expression word retrieving unit 22 select the atmosphere expression word corresponding to the sound pressure level, for example “Don Don”, from among the atmosphere expression words such that a non-metallic impression, being a dull impression, (including no high frequency sound) is given and yet the low-pitched sound is expressed when the frequency information is the frequency band and the center of gravity of the frequency, its band is narrow and the center of gravity of the frequency is low. On the other hand, the atmosphere expression word retrieving unit 22 may select the atmosphere expression word corresponding to the sound pressure level, for example “Kin Kin”, from among the atmosphere expression words such that a metallic impression, being a sharp impression, (including the high frequency sound) is given and yet the high-pitched sound is expressed when its band is wide and the center of gravity of the frequency is high.

Further, the atmosphere expression word superimposition effect controlling unit 31 selects
the font with size corresponding to the sound pressure level from among the rounded fonts as a font for displaying the atmosphere expression word such that a non-metallic impression, being a dull impression (including no high frequency sound) is given and yet the low-pitched sound is expressed when the frequency information is the frequency band and the center of gravity of the frequency, its band is narrow, and the center of gravity of the frequency is low. On the other hand, the atmosphere expression word retrieving unit 22 may select the font with size corresponding to the sound pressure level from among the fonts of which the tip and the shape are sharp and harsh, respectively, as a font for displaying the atmosphere expression word such that a metallic impression, being a sharp impression (including the high frequency sound) is given and yet the high-pitched sound is expressed when its band is wide and the center of gravity of the frequency is high.

The text data of the atmosphere expression words selected as mentioned above by the atmosphere expression word retrieving unit 22 is inputted into the atmosphere expression word superimposition video preparing unit 30.

Further, the type of the font, the font size, and the like selected by the atmosphere expression word superimposition effect controlling unit 31 are also inputted into the atmosphere expression word superimposition video preparing unit 30.

The atmosphere expression word superimposition video preparing unit 30 prepares the atmosphere expression word superimposition video by superimposing the atmosphere expression word coming from the atmosphere expression word retrieving unit 22 upon the video obtained by sketchily converting the original video coming from the video converting unit 32 with the type of the font and the font size designated by the atmosphere expression word superimposition effect controlling unit 31. And, the atmosphere expression word superimposition video preparing unit 30 outputs the atmosphere expression word superimposition video to the displaying unit 4.

The displaying unit 4 inputs the atmosphere expression word superimposition video from the atmosphere expression word video superimposing unit 3, and displays the video having the atmosphere expression word superimposed thereupon.

Additionally, a plurality of the items of the frequency information explained above may be employed.

Further, while an example of combining the sound pressure level and the frequency information was explained in the above-mentioned example, it is also possible to select the atmosphere expression word in some cases and to control the display effect of the atmosphere expression word in some case by employing only the frequency information.

As mentioned above, in the fifth exemplary embodiment, adding the frequency information to the atmospheric sound information besides the sound pressure level makes it possible to select the atmosphere expression word representing the atmosphere of the above field all the more, and to perform a more effective display for the atmosphere expression words.

### Sixth Exemplary Embodiment

The sixth exemplary embodiment will be explained.

The sixth exemplary embodiment is configured to discriminate the voice from the environmental sound other than the voice in terms of the audio signals acquired from the atmospheric sound that is being generated in a certain predetermined field and to prepare the atmospheric sound information by paying attention to magnitude of the sound, the frequency analysis, and the discrimination of the voice from the environmental sound, besides the configurations of the above-described exemplary embodiments. And, the sixth exemplary embodiment selects the atmosphere expression word suitable for the field in which the audio signals have been acquired based on the atmospheric sound information. In addition, an example of changing the display effect of the selected atmosphere expression word according to the classification of the sound will be explained.

FIG. 16 is a block diagram of the information display system of the sixth exemplary embodiment.

The input signal analyzing unit 1 includes a voice/environmental sound determining unit 12 besides the components of the above-described exemplary embodiments.

The voice/environmental sound determining unit 12 determines whether the inputted audio signals are the voice that a person has uttered or the other environmental sound. The following methods are thinkable as a determination method.

(1) The voice/environmental sound determining unit 12 determines that the audio signals are the environmental sound except the voice when a temporal change in a spectrum shape of the audio signals is too small (stationary noise) or too rapid (sudden noise).

(2) The voice/environmental sound determining unit 12 determines that the audio signals are the environmental sound except the voice when the spectrum shape of the audio signals is flat or near to 1/f.

(3) The voice/environmental sound determining unit 12 performs a linear prediction of several milliseconds or so (the tenth order for 8 kHz sampling) for the audio signals, and determines that the audio signals are the voice when its linear prediction gain is large, and the audio signals are the environmental sound when its linear prediction gain is small. Further, the voice/environmental sound determining unit 12 performs a long-time prediction of ten and several milliseconds or so (the 40th to 160th order for 8 kHz sampling) for the audio signals, and determines that the audio signals are the voice when its long-time prediction gain is large, and the audio signals are the environmental sound when its long-time prediction gain is small.

(4) The voice/environmental sound determining unit 12 converts the input sound of the audio signals into a cepstrum, measures a distance between the converted signal and a standard model of the voice, and determines that the audio signals are the environmental sound except the voice when the above input sound is distant by a constant distance or more.

(5) The voice/environmental sound determining unit 12 converts the input sound of the audio signals into a cepstrum, measures a distance between the converted signal and a standard model of the voice and a distance between the converted signal and a garbage model or a universal model, and determines that the above input sound is the environmental sound except the voice when the converted signal is near to the garbage model or the universal model.

As a standard model of the voice of the above-described model, Gaussian Mixture Model (GMM), Hidden Markov Model (HMM), and the like may be employed. The GMM and the HMM are prepared in advance statically from the voice that a person has uttered, or are prepared by employing an algorithm for machine learning. Additionally, the so-called garbage model is a model prepared from the sound other than utterance of a person, and the so-called universal model is a model prepared by all putting together the voice that a person has uttered and the sound other than it.

The input signal analyzing unit 1 outputs the sound pressure level calculated by the sound pressure level calculating unit 10, the frequency information calculated by the frequency analyzing unit 11, the classification of the sound (the voice, or the environmental sound other than the voice) calculated by the voice/environmental sound determining unit 12 as the atmospheric sound information to the atmosphere expression word retrieving unit 22 and the atmosphere expression word superimposition effect controlling unit 31.

The atmosphere expression word retrieving unit 22 of the sixth exemplary embodiment, which is similar to that of the above-described embodiments in a basic configuration, inputs the sound pressure level, the frequency information, and the classification of the sound (the voice, or the environmental sound other than the voice) as the atmospheric sound information, and retrieves the atmosphere expression word. For this reason, not only the sound pressure level and the frequency information but also the atmosphere expression words corresponding to the atmospheric sound information that has been learned in consideration of the classification as well of the voice or the environmental sound other than the voice are stored in the atmosphere expression word database 21.

The atmosphere expression word retrieving unit 22 retrieves the atmosphere expression word “Hiso Hiso (onomatopoeia in Japanese)” corresponding to the voice, for example, when the sound that is being generated in the field in which the audio signals have been acquired is the voice, the fundamental frequency is high, and the sound pressure level is low. On the other hand, the atmosphere expression word retrieving unit 22 retrieves the atmosphere expression word “Gaya Gaya” corresponding to the voice when the sound that is being generated in the field in which the audio signals have been acquired is the voice, the fundamental frequency is low, and the sound pressure level is high. Further, the atmosphere expression word retrieving unit 22 retrieves the atmosphere expression word corresponding to the environmental sound other than the voice, for example, the atmosphere expression word “Gon Gon” when the sound that is being generated in the field in which the audio signals have been acquired is the environmental sound other than the voice, the center of gravity of the frequency is low, and the sound pressure level is low. On the other hand, the atmosphere expression word retrieving unit 22 retrieves the atmosphere expression word corresponding to the environmental sound other than the voice, for example, the atmosphere expression word “Kin Kin” when the sound that is being generated in the field in which the audio signals have been acquired is the environmental sound other than the voice, the center of gravity of the frequency is high, and the sound pressure level is high. And, the retrieved atmosphere expression words are outputted according to a format that is used for text data, meta data such as Exif, and tags for retrieving moving pictures.

Additionally, when the sound is determined to be the voice by the voice/environmental sound determining unit 12, the atmosphere expression word retrieving unit 22 may analyze the number of talkers based on the sound pressure level and the frequency information, and may select the atmosphere expression word suitable for its number of the talkers. For example, the atmosphere expression word retrieving unit 22 retrieves “Butu Butu (onomatopoeia in Japanese)” when one parson talks in a small voice, “Waa” when one parson talks in a large voice, “Hiso Hiso” when a plurality of parsons talk in a small voice, and “Wai Wai” when a plurality of parsons talk in a large voice.

Additionally, while an example of combining the sound pressure level, the frequency information, and the discrimination of the voice from the environmental sound was explained in the above-mentioned example, it is also possible to select the atmosphere expression word by employing only the discrimination of the voice from the environmental sound, and by employing a combination of the sound pressure level and the discrimination of the voice from the environmental sound.

The atmosphere expression word text data selected in such a manner is outputted to the atmosphere expression word superimposition video preparing unit 30.

The atmosphere expression word superimposition effect controlling unit 31 of the sixth exemplary embodiment, which is similar to that of the above-described embodiments in a basic configuration, inputs the sound pressure level, the frequency information, and the classification of the sound (the voice, or the environmental sound other than the voice) as the atmospheric sound information, and controls the display effect of the atmosphere expression word.

For example, the atmosphere expression word superimposition effect controlling unit 31 takes a control of changing the display color of the atmosphere expression word depending on the classification of the sound in addition to the effect control of the above-described exemplary embodiments. Specifically, when the classification of the sound is the voice, a predetermined color, for example, black is employed as the display color of the atmosphere expression word. On the other hand, when the classification of the sound is the sound other than the voice, a predetermined color, for example, white is employed as the display color of the atmosphere expression word.

Changing the display color of the atmosphere expression word depending on the classification of the sound in such a manner allows the classification of the generation source of the sound to be easily recognized visually. Additionally, it is only example to change the display color of the atmosphere expression word, the control of the display color of the atmosphere expression word is not limited hereto. For example, the type of the font of the atmosphere expression word and the font size may be changed, depending on the classification of the sound.

The color and type of the font, the font size, and the like selected by the atmosphere expression word superimposition effect controlling unit 31 are inputted into the atmosphere expression word superimposition video preparing unit 30.

The atmosphere expression word superimposition video preparing unit 30 prepares the atmosphere expression word superimposition video by superimposing the atmosphere expression word retrieved by the atmosphere expression word retrieving unit 22 upon the video obtained by sketchily converting the original video coming from the video converting unit 32 with the color and type of the font and the font size designated by the atmosphere expression word superimposition effect controlling unit 31. And, the atmosphere expression word superimposition video preparing unit 30 outputs the atmosphere expression word superimposition video to the displaying unit 4.

The displaying unit 4 inputs the atmosphere expression word superimposition video from the atmosphere expression word video superimposing unit 3, and displays the video having the atmosphere expression word superimposed thereupon.

The sixth exemplary embodiment makes it possible to select and display the atmosphere expression word corresponding to the classification of the sound that is being generated in the field in which the audio signals have been acquired because the voice is discriminated from the environmental sound other than the voice.

### Seventh Exemplary Embodiment

The seventh exemplary embodiment will be explained.

The seventh exemplary embodiment is further configured to discriminate the classification of the environmental sound other than the voice, and to prepare the atmospheric sound information by paying attention to magnitude of the sound, the frequency analysis, and the discrimination of the atmospheric sound (the classification of the voice and the environmental sound such as the sound of the automobile), besides the configuration of the sixth exemplary embodiment. And, the seventh exemplary embodiment selects the atmosphere expression word suitable for the field in which the audio signals have been acquired based on the atmospheric sound information. In addition, an example of changing the display effect of the selected atmosphere expression word according to the classification of the sound will be explained.

FIG. 17 is a block diagram of the information display system of the seventh exemplary embodiment.

The input signal analyzing unit 1 includes a voice/environmental sound classification determining unit 13 besides the components of the above-mentioned exemplary embodiments.

The voice/environmental sound classification determining unit 13 determines the voice that a person has uttered, and the classification of the environmental sound other than the voice for the inputted audio signals. The method of using the GMM and the method of using the HMM are thinkable as a determination method. For example, the GMM and the HMM previously prepared for each type of the environmental sound other than the voice are stored, and the classification of the environmental sound of which a distance to the input sound is nearest is selected. The technology described in Literature “Spoken Language Processing 29-14, Environmental Sound Discrimination Based on Hidden Markov Model” may be referenced for the method of discriminating the classification of these environmental sounds.

The input signal analyzing unit 1 outputs the sound pressure level calculated by the sound pressure level calculating unit 10, the frequency information calculated by the frequency analyzing unit 11, the classification of the environmental sound (the classification of the environmental sounds such as the voice, the sound of the automobile, the sound of rain) calculated by the voice/environmental sound classification determining unit 13 as the atmospheric sound information to the atmosphere expression word retrieving unit 22 and the atmosphere expression word superimposition effect controlling unit 31.

The atmosphere expression word retrieving unit 22 inputs the sound pressure level, the frequency information, and the classification of the environmental sound (the classification of the environmental sounds such as the voice, the sound of the automobile, the sound of rain) as the atmospheric sound information, and selects the atmosphere expression word. For this reason, not only the sound pressure level and the frequency information but also the atmosphere expression word corresponding to the atmospheric sound information that has been learned in consideration of the classification as well of the voice or the environmental sound other than the voice are stored in the atmosphere expression word database 21.

For example, the atmosphere expression word retrieving unit 22 retrieves the atmosphere expression word “Kan Kan” corresponding to “the sound of striking metal” when the classification of the sound that is being generated in the field in which the audio signals have been acquired is “the sound of striking metal”, the center of gravity of the frequency is high, and the sound pressure level is low. On the other hand, the atmosphere expression word retrieving unit 22 retrieves the atmosphere expression word “Gan Gan” corresponding to “the sound of striking metal” when the classification of the sound that is being generated in the field in which the audio signals have been acquired is “the sound of striking metal”, the center of gravity of the frequency is low, and the sound pressure level is low. And, the text data of the retrieved atmosphere expression words is outputted to the atmosphere expression word superimposition video preparing unit 30.

Additionally, while an example of combining the sound pressure level, the frequency information, and the discrimination of the atmospheric sound was explained in the above-mentioned example, it is also possible to select the atmosphere expression word by employing only the discrimination of the atmospheric sound, and by employing a combination of the sound pressure level and the discrimination of the atmospheric sound.

The atmosphere expression word superimposition effect controlling unit 31 of the seventh exemplary embodiment, which is similar to that of above-described embodiments in a basic configuration, inputs the sound pressure level, the frequency information, and the classification of the sound (the classification of the voice and the environmental sound) as the atmospheric sound information, and controls the display effect of the atmosphere expression word.

For example, the atmosphere expression word superimposition effect controlling unit 31 takes a control of changing the display color of the atmosphere expression word depending on the classification of the sound in addition to the effect control of the above-described exemplary embodiments. Specifically, the atmosphere expression word superimposition effect controlling unit 31 takes a control in such a manner that the display color of the atmosphere expression word is a predetermined color depending on the classification of the environmental sound. For example, a water color is employed when the environmental sound is the sound of water, and a gray color is employed when the environmental sound is the sound of the automobile.

Discriminating the classification of the environmental sound itself and changing the display color of the atmosphere expression word in such a manner allows the classification of the generation source of the sound to be more easily recognized visually. Additionally, it is only one example to change the display color of the atmosphere expression word, the control of the display color of the atmosphere expression word is not limited hereto. For example, the type of the font of the atmosphere expression word and the font size may be changed, depending on the classification of the sound.

The color and type of the font, the font size, and the like selected by the atmosphere expression word superimposition effect controlling unit 31 are inputted into the atmosphere expression word superimposition video preparing unit 30.

The atmosphere expression word superimposition video preparing unit 30 prepares the atmosphere expression word superimposition video by superimposing the atmosphere expression word retrieved by the atmosphere expression word retrieving unit 22 upon the sketchily-converted video coming from the video converting unit 32 with the type and color of the font and the font size designated by the atmosphere expression word superimposition effect controlling unit 31. And, the atmosphere expression word superimposition video preparing unit 30 outputs the atmosphere expression word superimposition video to the displaying unit 4.

The displaying unit 4 inputs the atmosphere expression word superimposition video from the atmosphere expression word video superimposing unit 3, and displays the video having the atmosphere expression word superimposed thereupon.

The seventh exemplary embodiment makes it possible to select and display the atmosphere expression word corresponding to the classification of the sound that is being generated in the field in which the audio signals have been acquired because the classification of the environmental sound is discriminated in addition to the above-described embodiments.

### Eighth Exemplary Embodiment

The eighth exemplary embodiment is characterized in detecting a direction of the sound source, and adding this result to the display effect of the atmosphere expression word.

FIG. 18 is a block diagram of the information display system of the eighth exemplary embodiment.

The atmosphere expression word video superimposing unit 3 includes a sound source direction estimating unit 33 besides the components of the above-mentioned exemplary embodiments.

The method of calculating an arrival direction in the sound source direction estimating unit 33 will be explained by employing FIG. 19. In FIG. 19, it is supposed to record the sound with two microphones for simplification. It is assumed that a sound source 41 is sufficiently distant. Sensors are a microphone A 42 and a microphone B 43. It can be seen that a difference between times that the identical sound arrive at two microphones is produced at this time, depending on a direction of the arrival from the sound source and a positional relation between two microphones. When a difference of the arrival time and a sound velocity is defined as Δt and λ, respectively, an arrival distance difference d45 is represented by λ·Δt. And, when it is assumed that a distance between two microphones D44 is known, an angle Ø, being an arrival direction, can be calculated by Numerical equation 1.

$$cos ∅ = \frac{d}{D} = \frac{λ \cdot Δ t}{D} \qquad [ Numerical equation 1 ]$$

When the number of channels of the input signals is two or more, the arrival direction can be calculated from a pair of specific channels. Further, the arrival direction may be calculated with a plurality of pairs to integrate the calculated arrival directions. Calculating the arrival direction by employing a plurality of pairs makes it possible to calculate the arrival direction with a high accuracy.

The atmosphere expression word superimposition effect controlling unit 31 receives the arrival direction from the sound source direction estimating unit 33, estimates a position of the arrival direction of the sound over the video, and defines the above position as a superimposition position of the atmosphere expression word. And, the atmosphere expression word superimposition effect controlling unit 31 outputs this superimposition position of the atmosphere expression word, the color and type of the font of the atmosphere expression word, the font size and the like to the atmosphere expression word superimposition video preparing unit 30.

The atmosphere expression word superimposition video preparing unit 30 prepares the atmosphere expression word superimposition video by superimposing the atmosphere expression word retrieved by the atmosphere expression word retrieving unit 22 upon the sketchily-converted video coming from the video converting unit 32 with the position, the type and color of the font, and the font size designated by the atmosphere expression word superimposition effect controlling unit 31. And, the atmosphere expression word superimposition video preparing unit 30 outputs the atmosphere expression word superimposition video to the displaying unit 4.

The displaying unit 4 inputs the atmosphere expression word superimposition video from the atmosphere expression word video superimposing unit 3, and displays the video having the atmosphere expression word superimposed thereupon. The eighth exemplary embodiment makes it possible to visually recognize the direction of the sound source because the atmosphere expression word is superimposed in the position of the arrival direction of the sound over the video.

### Ninth Exemplary Embodiment

The ninth exemplary embodiment will be explained.

In the ninth exemplary embodiment, an example of taking action for selecting the atmosphere expression word only when the audio signals are in a certain constant level will be explained.

FIG. 20 is a block diagram of the information display system of the ninth exemplary embodiment.

The input signal analyzing unit 1 includes an activity determining unit 34 besides the components of the above-mentioned exemplary embodiments.

The activity determining unit 34 outputs the audio signals to the sound pressure level calculating unit 10, the frequency analyzing unit 11, the voice/environmental sound classification determining unit 13, and the sound source direction estimating unit 33 only when the audio signals are in a certain constant level.

The ninth exemplary embodiment makes it possible to prevent the wasteful process of selecting the atmosphere expression word, and the like because the action for selecting the atmosphere expression word is taken only when the audio signals are in a certain constant level.

### Tenth Exemplary Embodiment

The tenth exemplary embodiment will be explained.

In the tenth exemplary embodiment, an example of performing the above-described exemplary embodiments by a computer that operates under a program will be explained.

FIG. 21 is a block diagram of the information display system of the tenth exemplary embodiment.

The information display system of the tenth exemplary embodiment includes a computer 50 and an atmosphere expression word database 21.

The computer 50 includes a program memory 52 having the program stored therein, and a CPU 51 that operates under the program.

The CPU 51 performs the process similar to the operation of the sound pressure level calculating unit 10 in a sound pressure level calculating process 100, the process similar to the operation of the frequency analyzing unit 11 in a frequency analyzing process 101, the process similar to the operation of the voice/environmental sound determining unit 12 in a voice/environmental sound determining process 102, and the process similar to the operation of the atmosphere expression word retrieving unit 22 in an atmosphere expression word retrieving process 200.

Further, the CPU 51 performs the process similar to the operation of the atmosphere expression word superimposition video preparing unit 30 in an atmosphere expression word superimposition video preparing process 300, the process similar to the operation of the atmosphere expression word superimposition effect controlling unit 31 in an atmosphere expression word superimposing effect controlling process 301, the process similar to the operation of the video converting unit 32 in a video converting process 302, and the process similar to the operation of the sound source direction estimating unit 33 in a sound source direction estimating process 303.

Additionally, the atmosphere expression word database 21 may be stored inside the computer 50.

Further, while the action under the program equivalent to the process of the eighth exemplary embodiment was exemplified in this exemplary embodiment, the action under the program is not limited hereto, and the action under the program equivalent to the process of the above-described other exemplary embodiments may be realized with the computer.

Further, the content of the above-mentioned exemplary embodiments can be expressed as follows.

(Supplementary note 1) An information display system, comprising:

a signal analyzing unit that analyzes audio signals obtained from a predetermined field, and prepares atmospheric sound information related to a sound that is being generated in said predetermined field;

an atmosphere expression word selecting unit that selects an atmosphere expression word expressing what a person feels from the sound that is being generated in said acquisition location based on said atmospheric sound information; and

an atmosphere expression word video superimposing unit that superimposes said atmosphere expression word upon a video of video signals obtained from said predetermined field.

(Supplementary note 2) The information display system according to Supplementary note 1, wherein said atmosphere expression word is at least one of an onomatopoeic word and a mimetic word.

(Supplementary note 3) The information display system according to Supplementary note 1 or Supplementary note 2, wherein said signal analyzing unit analyzes at least one of a sound pressure level of the audio signals, frequency information representing features of a frequency of the audio signals, and a classification of the sound of the audio signals, and prepares the atmospheric sound information.

(Supplementary note 4) The information display system according to one of Supplementary note 1 to Supplementary note 3, wherein said atmosphere expression word video superimposing unit comprises:

an atmosphere expression word superimposition effect controlling unit that decides at least one of a superimposition position, a shape, magnitude, and a color of the atmosphere expression word to be superimposed upon said video; and

an atmosphere expression word superimposition video preparing unit that prepares an atmosphere expression word superimposition video by superimposing the atmosphere expression word upon said video with said decided superimposition position, shape, magnitude or color.

(Supplementary note 5) The information display system according to Supplementary note 4, wherein said atmosphere expression word superimposition effect controlling unit detects at least one of a movement of said video, a change in a color, a change in luminance, and a change in an edge, and decides the superimposition position of said atmosphere expression word.

(Supplementary note 6) The information display system according to Supplementary note 4 or Supplementary note 5, wherein said atmosphere expression word superimposition effect controlling unit decides at least one of the shape, the magnitude and the color of the atmosphere expression word to be superimposed upon said video, based on at least one of the sound pressure level of the audio signals analyzed by said signal analyzing unit, the frequency information representing the features of the frequency of the audio signals, and the classification of the sound of the audio signals.

(Supplementary note 7) The information display system according to one of Supplementary note 1 to Supplementary note 6:

wherein said atmosphere expression word video superimposing unit comprises a video converting unit that converts the video of the video signals obtained from said predetermined field into a sketchy video; and

wherein said atmosphere expression word superimposition video preparing unit prepares the atmosphere expression word superimposition video by superimposing said atmosphere expression word upon said converted video.

(Supplementary note 8) The information display system according to one of Supplementary note 1 to Supplementary note 7:

wherein said atmosphere expression word video superimposing unit comprises an arrival direction estimating unit that estimates a position of an arrival direction of the sound over the video based on said audio signals; and

wherein said atmosphere expression word superimposition video preparing unit superimposes said atmosphere expression word at said estimated video position of the arrival direction of the sound.

(Supplementary note 9) An information display method, comprising:

analyzing audio signals obtained from a predetermined field, and preparing atmospheric sound information related to a sound that is being generated in said predetermined field;

selecting an atmosphere expression word expressing what a person feels from the sound that is being generated in said acquisition location based on said atmospheric sound information; and

superimposing said atmosphere expression word upon a video of video signals obtained from said predetermined field.

(Supplementary note 10) The information display method according to Supplementary note 9, wherein said atmosphere expression word is at least one of an onomatopoeic word and a mimetic word.

(Supplementary note 11) The information display method according to Supplementary note 9 or Supplementary note 10, comprising analyzing at least one of a sound pressure level of said audio signals, frequency information representing features of a frequency of the audio signals, and a classification of the sound of the audio signals, and preparing the atmospheric sound information.

(Supplementary note 12) The information display method according to one of Supplementary note 9 to Supplementary note 11, comprising:

deciding at least one of a superimposition position, a shape, magnitude, and a color of the atmosphere expression word to be superimposed upon said video; and

preparing an atmosphere expression word superimposition video by superimposing the atmosphere expression word upon said video with said decided superimposition position, shape, magnitude or color.

(Supplementary note 13) The information display method according to Supplementary note 12, comprising detecting at least one of a movement of said video, a change in a color, a change in luminance and a change in an edge, and deciding the superimposition position of said atmosphere expression word.

(Supplementary note 14) The information display method according to Supplementary note 12 or Supplementary note 13, comprising deciding at least one of the shape, the magnitude and the color of the atmosphere expression word to be superimposed upon said video, based on at least one of the sound pressure level of said analyzed audio signals, the frequency information representing the features of the frequency of the audio signals, and the classification of the sound of the audio signals.

(Supplementary note 15) The information display method according to one of Supplementary note 9 to Supplementary note 14, comprising:

converting the video of the video signals obtained from said predetermined field into a sketchy video; and

preparing the atmosphere expression word superimposition video by superimposing said atmosphere expression word upon said converted video.

(Supplementary note 16) The information display method according to one of Supplementary note 9 to Supplementary note 14, comprising:

estimating a position of an arrival direction of the sound over the video based on said audio signals; and

superimposing said atmosphere expression word at said estimated video position of the arrival direction of the sound.

(Supplementary note 17) A program for causing an information processing apparatus to execute:

a signal analyzing process of analyzing audio signals obtained from a predetermined field, and preparing atmospheric sound information related to a sound that is being generated in said predetermined field;

an atmosphere expression word selecting process of selecting an atmosphere expression word representing what a person feels from the sound that is being generated in said acquisition location based on said atmospheric sound information; and

an atmosphere expression word video superimposing process of superimposing said atmosphere expression word upon a video of video signals obtained from said predetermined field.

Above, although the present invention has been particularly described with reference to the preferred embodiments, it should be readily apparent to those of ordinary skill in the art that the present invention is not always limited to the above-mentioned embodiments, and changes and modifications in the form and details may be made without departing from the spirit and scope of the invention.

This application is based upon and claims the benefit of priority from Japanese patent application No. 2010-078122, filed on Mar. 30, 2010, the disclosure of which is incorporated herein in its entirety by reference.

### REFERENCE SIGNS LIST

1 input signal analyzing unit

2 atmosphere expression word selecting unit

3 atmosphere expression word video superimposing unit

10 sound pressure level calculating unit

11 frequency analyzing unit

12 voice/environmental sound determining unit

13 voice/environmental sound classification determining unit

21 atmosphere expression word database

22 atmosphere expression word retrieving unit

30 atmosphere expression word superimposition video preparing unit

31 atmosphere expression word superimposition effect controlling unit

32 video converting unit

33 sound source direction estimating unit

34 activity determining unit

50 computer

51 CPU

52 program memory

1. An information display system, comprising:
a signal analyzing unit that analyzes a sound pressure level of the audio signals and a classification of the sound of the audio signals, by analyzing audio signals obtained from a predetermined field, and prepares atmospheric sound information related to a sound that is being generated in said predetermined field;
an atmosphere expression word selecting unit that selects an atmosphere expression word expressing what a person feels from the sound that is being generated in said acquisition location based on said atmospheric sound information; and
an atmosphere expression word video superimposing unit that superimposes said atmosphere expression word upon a video of video signals obtained from said predetermined field.

2. The information display system according to claim 1, wherein said atmosphere expression word is at least one of an onomatopoeic word and a mimetic word.

3. The information display system according to claim 1, wherein said signal analyzing unit analyzes frequency information representing features of a frequency of the audio signals in addition to analyze said sound pressure level of the audio signals and said classification of the sound of the audio signals, and prepares the atmospheric sound information.

4. The information display system according to one of claim 1, wherein said atmosphere expression word video superimposing unit comprises:
an atmosphere expression word superimposition effect controlling unit that decides at least one of a superimposition position, a shape, magnitude, and a color of the atmosphere expression word to be superimposed upon said video; and
an atmosphere expression word superimposition video preparing unit that prepares an atmosphere expression word superimposition video by superimposing the atmosphere expression word upon said video with said decided superimposition position, shape, magnitude or color.

5. The information display system according to claim 4, wherein said atmosphere expression word superimposition effect controlling unit detects at least one of a movement of said video, a change in a color, a change in luminance, and a change in an edge, and decides the superimposition position of said atmosphere expression word.

6. The information display system according to claim 4, wherein said atmosphere expression word superimposition effect controlling unit decides at least one of the shape, the magnitude and the color of the atmosphere expression word to be superimposed upon said video, based on at least one of the sound pressure level of the audio signals analyzed by said signal analyzing unit, the frequency information representing the features of the frequency of the audio signals, and the classification of the sound of the audio signals.

7. The information display system according to claim 1:
wherein said atmosphere expression word video superimposing unit comprises a video converting unit that converts the video of the video signals obtained from said predetermined field into a sketchy video; and
wherein said atmosphere expression word superimposition video preparing unit prepares the atmosphere expression word superimposition video by superimposing said atmosphere expression word upon said converted video.

8. The information display system according to claim 1:
wherein said atmosphere expression word video superimposing unit comprises an arrival direction estimating unit that estimates a position of an arrival direction of the sound over the video based on said audio signals; and
wherein said atmosphere expression word superimposition video preparing unit superimposes said atmosphere expression word at said estimated video position of the arrival direction of the sound.

9. An information display method, comprising:
analyzing a sound pressure level of the audio signals and a classification of the sound of the audio signals, by analyzing audio signals obtained from a predetermined field, and preparing atmospheric sound information related to a sound that is being generated in said predetermined field;
selecting an atmosphere expression word expressing what a person feels from the sound that is being generated in said acquisition location based on said atmospheric sound information; and
superimposing said atmosphere expression word upon a video of video signals obtained from said predetermined field.

10. The information display method according to claim 9, wherein said atmosphere expression word is at least one of an onomatopoeic word and a mimetic word.

11. The information display method according to claim 9, comprising analyzing frequency information representing features of a frequency of the audio signals, in addition to analyze said sound pressure level of the audio signals and said classification of the sound of the audio signals, and preparing the atmospheric sound information.

12. The information display method according to claim 9, comprising:
deciding at least one of a superimposition position, a shape, magnitude, and a color of the atmosphere expression word to be superimposed upon said video; and
preparing an atmosphere expression word superimposition video by superimposing the atmosphere expression word upon said video with said decided superimposition position, shape, magnitude or color.

13. The information display method according to claim 12, comprising detecting at least one of a movement of said video, a change in a color, a change in luminance and a change in an edge, and deciding the superimposition position of said atmosphere expression word.

14. The information display method according to claim 12, comprising deciding at least one of the shape, the magnitude and the color of the atmosphere expression word to be superimposed upon said video, based on at least one of the sound pressure level of said analyzed audio signals, the frequency information representing the features of the frequency of the audio signals, and the classification of the sound of the audio signals.

15. The information display method according to claim 9, comprising:
converting the video of the video signals obtained from said predetermined field into a sketchy video; and
preparing the atmosphere expression word superimposition video by superimposing said atmosphere expression word upon said converted video.

16. The information display method according to claim 9, comprising:
estimating a position of an arrival direction of the sound over the video based on said audio signals; and
superimposing said atmosphere expression word at said estimated video position of the arrival direction of the sound.

17. A non-transitory computer readable storage medium storing a program for causing an information processing apparatus to execute:
a signal analyzing process of analyzing a sound pressure level of the audio signals and a classification of the sound of the audio signals, by analyzing audio signals obtained from a predetermined field, and preparing atmospheric sound information related to a sound that is being generated in said predetermined field;
an atmosphere expression word selecting process of selecting an atmosphere expression word representing what a person feels from the sound that is being generated in said acquisition location based on said atmospheric sound information; and
an atmosphere expression word video superimposing process of superimposing said atmosphere expression word upon a video of video signals obtained from said predetermined field.
